(19) United States
(12) Patent Application Publication
(10) Pub. No.: US 2016/0379507 A1
(43) Pub. Date: Dec. 29, 2016

(54) System and Method for Motivating a User to Achieve a Goal

(71) Applicant: Girl Zone Corp., South Burlington, VT (US)

(72) Inventor: Mary Jo Reale, South Burlington, VT (US)

(21) Appl. No.: 15/191,208

(22) Filed: Jun. 23, 2016

Related U.S. Application Data
(60) Provisional application No. 62/183,696, filed on Jun. 23, 2015.

(51) Int. Cl. G09B 5/12; G09B 19/00; G06Q 30/02

(52) U.S. Cl. CPC G09B 5/125; G06Q 30/0241; G09B 19/0092

(57) ABSTRACT

A system motivates a user to achieve a goal by selecting electronic content that is relevant to the goal, and correlating the electronic content with at least one electronically interactive incentive geared toward achieving the goal. The system presents a challenge to the user via an electronic interface, where the challenge comprises the electronic content and/or the individualized electronically interactive incentive. The system receives, via the electronic interface, a response to the challenge from the user. The system then tracks the user's progress toward attaining at least one electronically interactive incentive by electronically monitoring the account associated with the user. The system renders a representation of the user's progress for the user via the electronic interface. The system provides the user with an option to receive at least one electronically interactive incentive as a physical item when the user has attained the electronically interactive incentive.

### CROSS REFERENCE TO RELATED APPLICATIONS

The present application claims priority to U.S. provisional patent application Ser. No. 62/183,696, filed on Jun. 23, 2015, entitled, “System and Method for Increasing Health and Fitness Awareness,” the contents and teachings of which are hereby incorporated by reference in their entirety.

### BACKGROUND

People often know what they should be doing to better their lives, and reach their goals. Frequently, the problem is finding the motivation to implement the behaviors needed to achieve those goals. For example, no matter what your age or fitness level, most people know that exercise and proper nutrition play a dominant role in one's current, as well as long term, health. Although most people, even young people, know that good nutrition and regular exercise pays dividends in one's health over the course of a lifetime, it can be challenging to practice better nutrition and regular exercise as well as other good lifestyle choices, such as getting plenty of rest. One obstacle to achieving goals is the amount of time that most of us, irrespective of age, spend engaged with our electronic devices, whether computers, smart phones, televisions, or video games.

The disconnect between, for example, knowing that exercise and good nutrition are beneficial and actually making changes to integrate these practices into one's life is particularly acute for young people. According to the Center for Disease Control and Prevention, childhood obesity has more than doubled in children and quadrupled in adolescents in the past 30 years. The CDC attributes this increase in childhood obesity to “caloric imbalance,” i.e., too few calories expended for the amount of calories consumed. This caloric imbalance is influenced by genetic, behavioral, and environmental factors. The physically ill effects of childhood obesity are numerous and can be found, for example, on the CDC's website at www.cdc.gov/healthyyouth/obesity/facts.htm.

The deleterious effects of being overweight are not just physical. The U.S. Department of Health sponsors a website called girlshealth, which features a panoply of information on the physical, as well as mental and emotional benefits of good nutrition and regular exercise. This website, which can be found at girlshealth.gov, is packed full of information for young women touting the physical, mental, and emotional benefits of regular exercise. Yet, despite the wealth of information available to young people regarding the benefits of regular exercise and proper nutrition, obesity statistics keep growing year after year. In 2012, for example, the CDC reported that more than one third of all children and adolescents in the United States were overweight or obese.

For anyone who has ever sworn to start exercising, to take off some weight, or to live a healthier lifestyle, one of the greatest challenges in achieving those goals is the motivation to put the words into action. In some instances, an incentive such as a reward if one succeeds in achieving a goal can be the difference between mere words and actual success. There have also been a number of studies conducted that show providing a reward system can help implement positive changes in behavior.

Although there is an enormous amount of information available electronically about different nutritional programs, exercise regimes, and healthy habits, much of the material that is online is directed toward an adult population. A second obstacle, therefore, for young people who may want to make lifestyle changes in their daily habits is finding material that is written specifically for them and that captures their interest.

Given the ever increasing incidence of obesity in young people, there is a need to provide motivation as well as access to salient materials for young people who desire to adopt a healthier lifestyle. On a broader scale, there is a need to provide motivation to a user to achieve a goal.

### SUMMARY

The present invention is directed to the challenge of aligning electronic media with user preferences to motivate a user to achieve a goal. Presently, there is a wealth of online information, for example, related to health, fitness and nutrition. The challenge, particularly for young people, is weeding through all of that information and honing in on relevant material that will motivate the user to achieve a goal, for example, to enhance the physical fitness, nutritional and lifestyle habits of young people. One of the key aspects of the present inventive systems and methods is uniquely combining motivational techniques with social media, educational materials, and an interactive electronic interface such that users will be encouraged to achieve their goals.

The methods disclosed herein create a culture and community in an electronic medium that allows participants to find not only motivation but also solid scientific premises and peer support to achieve their goals. For example, through the social media networking module the inventive method utilizes the fact that people tend to adopt the habits of their friends in order to support, encourage and create healthy habit changes. The inventive methods disclosed herein overcome inherent barriers faced by young individuals in current society.

Moreover, the methods disclosed herein overcome business challenges for retailers and manufacturers who may want to create store and brand loyalty with consumers who, for example, are cognizant of their fitness, health and nutrition. By matching these individuals with retailers and brands who sell, for example, healthy foods, exercise and sporting apparel or other wellness goods, the inventive methods overcome that barrier. In addition, the inventive method provides a platform for advertisers and sponsors not only to be matched to their target audience, but also to allow them an interactive platform to do so by providing the ability to sponsor challenges and get their brand message to their target audience through any number of promotional incentives.

Additionally, for parents of young people who may want to instill a philosophy of achieving goals, such as health, wellness and fitness in their children, the invention described herein aids those parents in providing a platform that speaks to their children in their “own language,” as opposed to the voice of a parent, thereby mitigating the naturally resistive tendencies of young people to do the opposite of what their parents may say is good for them. Combining the rewards module to encourage healthy behavior along with the social networking module to provide community support are two examples of how the current invention influences and motivates young people to adopt healthy lifestyle behaviors.

According to one embodiment disclosed herein, in a method for motivating a user to achieve a goal, the method selects electronic content relevant to the goal, and correlates the electronic content with at least one electronically interactive incentive geared toward achieving the goal. The method presents a challenge to the user via an electronic interface, where the challenge comprises at least one of the electronic content and the individualized electronically interactive incentive. The method receives, via the electronic interface, a response to the challenge from the user. The method then tracks the user's progress toward attaining at least one electronically interactive incentive by electronically monitoring the account associated with the user. The method renders a representation of the user's progress for the user via the electronic interface. The method provides the user with an option to receive at least one electronically interactive incentive as a physical item when the user has attained at least one electronically interactive incentive.

In one aspect of embodiments disclosed herein, when the method correlates the electronic content with at least one electronically interactive incentive geared toward achieving the goal, the method solicits at least one of the electronic content and the electronically interactive incentive from a provider as a means of advertisement for the provider.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 is a diagram of a system for motivating a user to achieve a goal.

FIG. 2 is a diagram illustrating completion of a challenge within the system of FIG. 1.

FIG. 3 illustrates example screen shots of the system of FIG. 1 where the application is geared toward young girls and young ladies.

FIG. 4 illustrates example screen shots of the system of FIG. 1 where the challenges are geared toward young girls and young ladies.

FIG. 5 illustrates example screen shots of the system of FIG. 1 where the electronically interactive incentives are geared toward young girls and young ladies.

FIG. 6 illustrates example screen shots of the system of FIG. 1 where the application is geared toward consumers of grocery stores and household products.

FIG. 7 illustrates example screen shots of the system of FIG. 1 where the challenges are geared toward a manufacturer's product.

FIG. 8 illustrates example screen shots of the system of FIG. 1 where the electronically interactive incentives are geared toward consumers of grocery stores and household products.

FIG. 9 illustrates example screen shots of the system of FIG. 1 where the system renders a representation of the user's progress via the electronic interface

### DETAILED DESCRIPTION

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein interchangeably as a “module,” “component” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

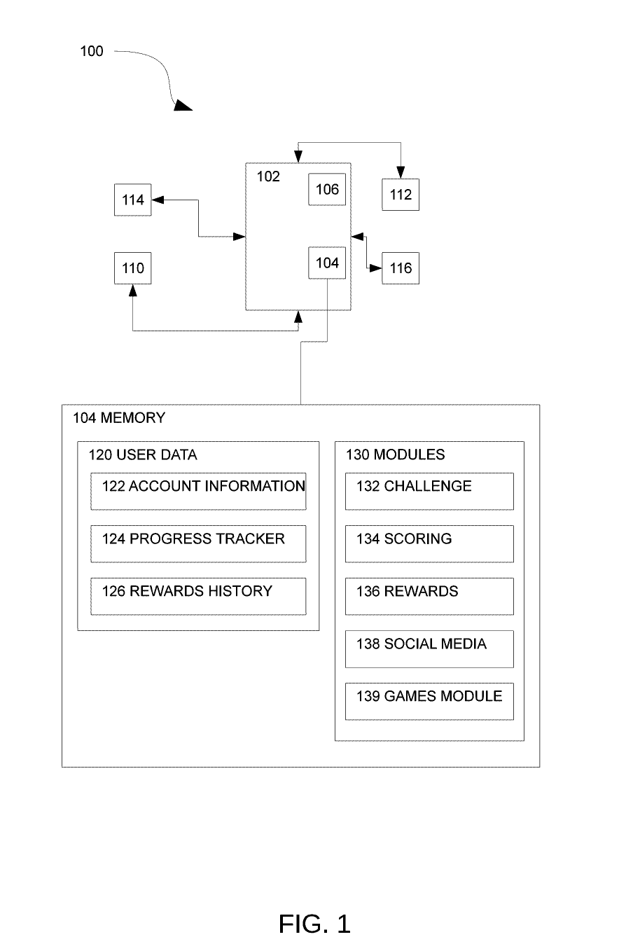

FIG. 1 illustrates a system in which the methods described herein can be implemented. The system is comprised of a server 102 having a memory 104 located therein. The server 102 further comprises a processor 106 interconnected with the server 102 and the memory 104. The server 102, processor 106, and memory 104 are configured to communicatively couple to external devices through input/output means not shown but well known to those of skill in the art. External devices could, in some embodiments, be comprised of smart phones 110 and 112, a tablet 114, and a laptop 116 or desktop computer. Each external device may belong to an individual user of the methods described herein. In terms of the communicative coupling between the external devices and the server 102, processor 106, and memory 104, the communicative connection could be made wirelessly or in a wired fashion, both of which are well understood within the art.

The server 102 may be in data communication with a memory 104. The memory 104 may include one or more non-transitory data storage devices and/or one or more transitory data storage devices. In particular, the memory 104 may include random access memory (RAM) for operational use of the server 102, one or more hard drives hard drive or other local persistent storage for facilitating performance of methods disclosed herein, and one or more databases for storing large data sets.

The memory 104 may store user data 120 for users who interact with the server 102 by means of a smart phone 112, 114, a tablet 114, or a laptop 116 or desk top. The user data 120 may include account information 122, progress tracking 124, and reward history 126, as described below. Account information 122 can include a username, password, identification information, demographic information, and Facebook, Instagram, Pintrest, or Twitter account information. The account information 122 may include information gathered from the user based on interaction with the user or provided expressly by the user when setting up or editing a profile. Similarly, the account information 122 could include information shared across social media platforms including, but not limited to, Facebook, Instagram, Pintrest and Twitter.

The progress tracker 124 can comprise stored data related to a user's interaction with the website facilitating methods disclosed herein, as well as a user's interaction with social media platforms, as previously described and known in the art. One of the goals of the present invention is to incentivize young people, and in alternate embodiments people of any age, to positively modify their nutrition, lifestyle and exercise habits. Toward that end, the methods disclosed herein provide educational materials, tests, vignettes, games, and anecdotes designed to motivate individuals to begin or continue along a path of heightened nutritional awareness, healthy lifestyle changes, and/or increased physical activity. The methods disclosed herein accomplish that by providing incremental rewards to users when they achieve milestones which are tracked by the progress tracker 124. These rewards can be in the form of peer recognition, self-directed accomplishments, prizes, products, or sweepstakes rewards, each of which will be described in further detail below. Rewards history 126 provides a chronology of the rewards a user has received during the course of her interaction with the system 100.

Rewards history 126 can be used to tailor rewards to a particular user based on her preferences, which could be stored as part of user data in account information 122, or within the rewards history 126 portion of the system 100. Additionally, rewards history 126 could include rewards preferences gleaned from analyzing and tracking social media postings and history.

By way of example, if a particular user posted several photographs of a ski trip she had taken on Instagram, the inventive system 100 could analyze those photographs to determine that that particular user was a skier. The methods disclosed herein could utilize algorithms and data analysis to correlate a ski incentive to that particular user is she won a sweepstakes and if the available prizes for that sweepstakes included something related to skiing.

One of the key elements of the present invention is that it correlates information from a variety of sources and uniquely and individually provides relevant incentives to an individual user. This correlation requires (1) providing relevant, current, and accurate health, wellness and fitness information; (2) monitoring a user's social media presence and internal responses to and interaction with the various modules of the present invention; and (3) using motivational techniques uniquely tailored to a particular user to instill a desire to become more nutritionally, mentally and physically healthy. These data and this correlation cannot be done by absent the unique behavioral models and tracking systems employed by the current invention.

In terms of the modules 130 of the present invention, several modules are disclosed herein including a challenge module 132, a scoring module 134, a rewards module 136, a social media module 138, and a gaming module 139. The challenge module 132 may be comprised of personality tests designed to teach the user about her personality type and in particular what types of fitness, lifestyle or nutrition challenges she may face based upon her personality type. The challenge module 132 may also include games or social media challenges such as sharing a fitness goal or achievement online within a social media network or competing against other users via social media to achieve a health goal such as weight loss. By sharing a goal or an achievement, a user can access peer approval thereby enhancing her motivation to continue toward her goals of better nutrition, physical fitness and/or overall health.

The challenge modules 132 may be parsed into different categories such as physical fitness, nutrition, lifestyle and emotional well-being. An individual's overall performance could be tested and ranked within each of these different categories. The challenge module 132 is designed to educate and motivate in a way that keeps users engaged in the pursuit of better overall health. The educational and motivational materials are specifically tailored to an audience, in one embodiment, young women ages 13 to 19.

In order to tailor the materials to a specific audience, it is necessary to understand what motivates individuals within the particular audience, as well as what typically derails individuals within that audience from long-term success. The materials presented to users are designed to meet this challenge. Additionally, they rely on information gleaned from sociological analysis of current trends and social media to optimally provide material to the users.

The present invention also includes a scoring module 134 that is used to score and record a user's performance on any given test. The test could be a written test or it could be a fitness or nutritional challenge, by way of example only. The scoring module 134 may be coupled to the progress tracker 124 so that a user can easily keep track of her progress on any given aspect of the inventive behavior modalities. The scoring module 134 can provide feedback to a user for example suggesting additional study material for areas where she performed poorly or additional sources of motivation if the user fell short of her goals.

The rewards module 136 may contain a current list of all merchandisers who have provided incentives to motivate users. Incentives may be provided as, without limitation, gift certificates to food establishments that sell healthy foods, sellers of sporting goods or sporting apparel, personal training gift certificates, a membership to a gym, ski passes, sneaker coupons, gift certificates to purchase music, spa coupons, gift certificates to clothing stores, sample products, or other gift-certificates or products, to name but a few examples. As described above, user reward preferences may be gleaned from analyzing and tracking social media postings and history. Alternatively, users may be given a selection of rewards to choose from, or a survey of the types of rewards that appeal to the user may be given. The user preferences may be shared with advertisers in order to present rewards that appeal to the individual user. In addition, prizes may be given out as part of the rewards module for winning a particular challenge against other members, as also described herein.

Each of the possible rewards within the rewards module 136 could be tracked globally to ensure that real-time accounting was being performed in such a way so as not to exceed or fall short of a particular gift provided by a particular vendor. Rewards module 136 could be coupled to progress tracker 124 so that a user would be entered into a sweepstakes, thereby entitling her to receive a reward, once she had attained a certain goal. Additionally, rewards module 136 could be coupled to rewards history 126 so that a user would not be given the same reward more than once or alternatively so that a second award was complimentary of a first award received by the user.

Social media module 138 facilitates interaction with external social media websites such as Facebook, Instagram, Pinterest, and Twitter, among others. Users of the present methods, via social media module 138, can post various milestones achieved through the currently disclosed methods on one or more social media platforms. Additionally, social media module 138 may access user's social media platforms to discern particular likes and preferences as a means of tailoring content made available to users via the challenge module 132 of the present invention.

Gaming module 139 may contain a separate storehouse for games in an alternate embodiment. While games could be included in the challenge module 132, it may be advantageous to include a separate gaming module 139. The games within gaming module 139 could be individual games or online games designed to increase nutritional, lifestyle and physical fitness awareness. The types and number of games included are not limited and could be played against another player online, or could be challenge games, like Words-With-Friends, played across multiple platforms where players challenge each other interactively.

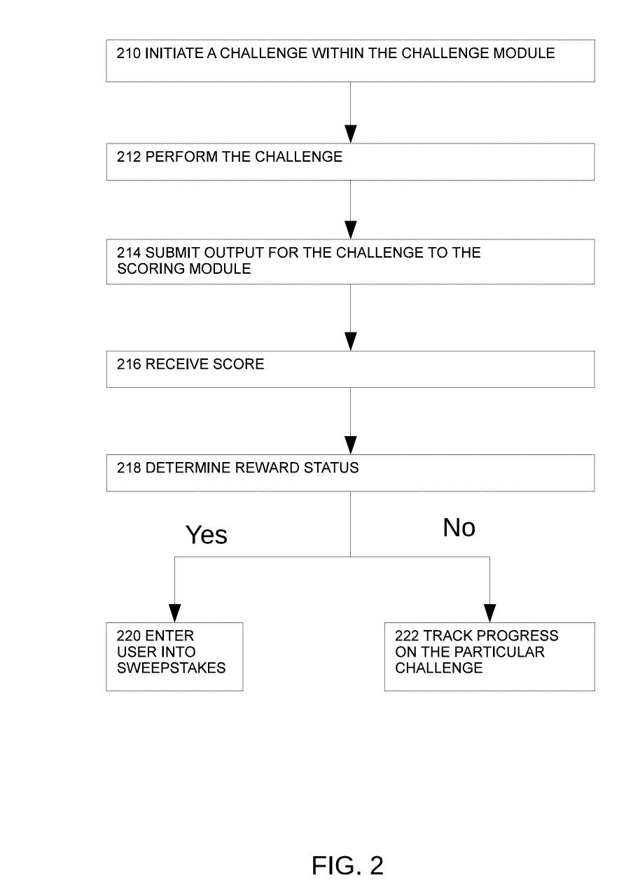

A method for completing a challenge within the challenge module 132 of the present invention is shown in FIG. 2. In this embodiment, a user could for example initiate 210 a particular challenge within a challenge module 132. The particular challenge could be an online quiz, playing a game, posting to social media (for example a picture or video), sharing a recipe, redeeming a coupon, or performing a fitness challenge, to name a few examples. When the user initiates the challenge 210, for example taking the quiz, she could retrieve an online quiz from the challenge module 132. Once she has access to the online quiz, she can perform 212 the challenge. In the situation where the particular challenge is an online quiz, performing 212 the challenge could be answering questions. In alternate embodiments, the challenge could be playing a game, participating in a fitness challenge, or posting something to a social media platform, without limitation.

Once the user has completed the challenge, she could submit 214 her output to the scoring module 134. Her output could be evaluated by the scoring module 134 to determine if she has successfully completed that particular challenge. In the case of an online quiz or a game, successful completion could mean attaining a certain score. In the case of an online social media post, successful completion could be verification that something satisfying the challenge was in fact posted to a social media platform.

Once the scoring module 134 has determined if the user has successfully completed the particular challenge within a challenge module 132, the scoring module 134 can communicate the results to progress tracker 124 and to the user, who would thereby receive 216 her score. Progress tracker 124 can tally each individual challenge that a user has successfully completed to track the user's progress.

In some embodiments, it may be beneficial from a behavioral modification standpoint for a user to complete several modules within a particular challenge stored in challenge module 132. If, for example, there are four sub-challenges within a nutrition challenge module, a user may have to complete each of these four sub-challenges before she has completed the entire nutrition module. Accordingly, the next step in this inventive method could be determining 218 if a user has qualified for a reward.

If a user has qualified for a reward, her information, which may be obtained from account information 122, can be entered into the rewards history 126 aspect of the present invention. Once her information is entered into the rewards history 126 aspect of the present invention, two things can happen. First, the user could be entered into a sweepstakes to win a gift certificate as described above. Second, the user's entry into the sweepstakes and her winning history could be tracked to determine if the user received a reward and if so, from whom did she receive the reward. If the user has not qualified for a reward, either because her score was insufficient or because she had not completed all of the requisite challenges within a challenge module, her progress could be tracked 222 for future reference and determination as to whether she should be submitted to a sweepstakes or other reward.

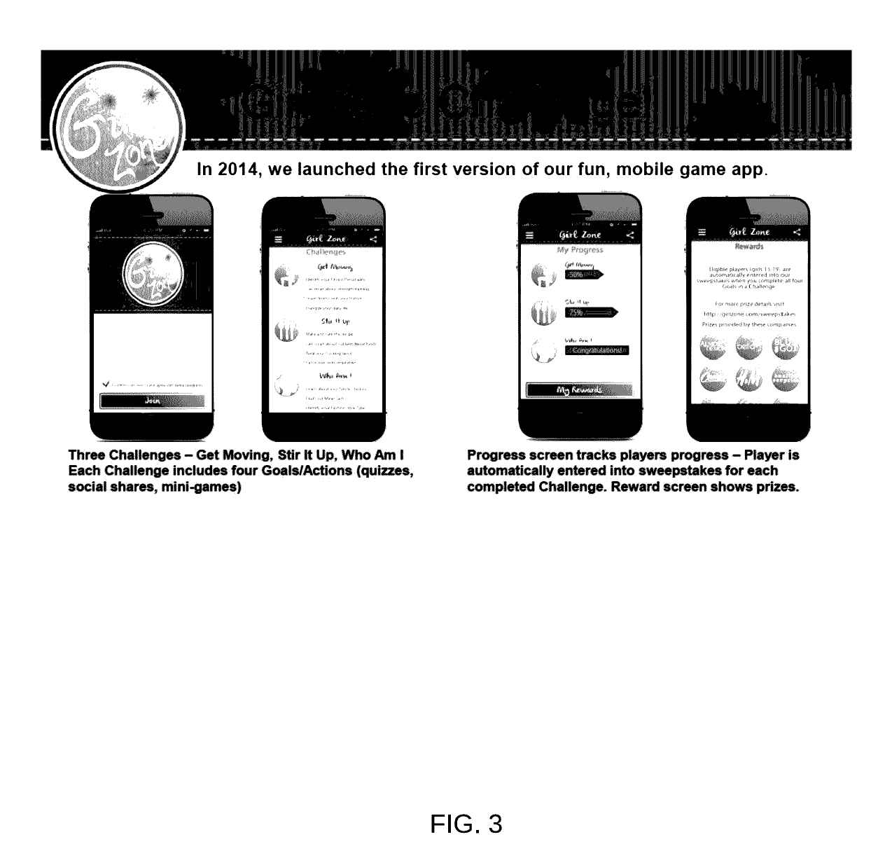

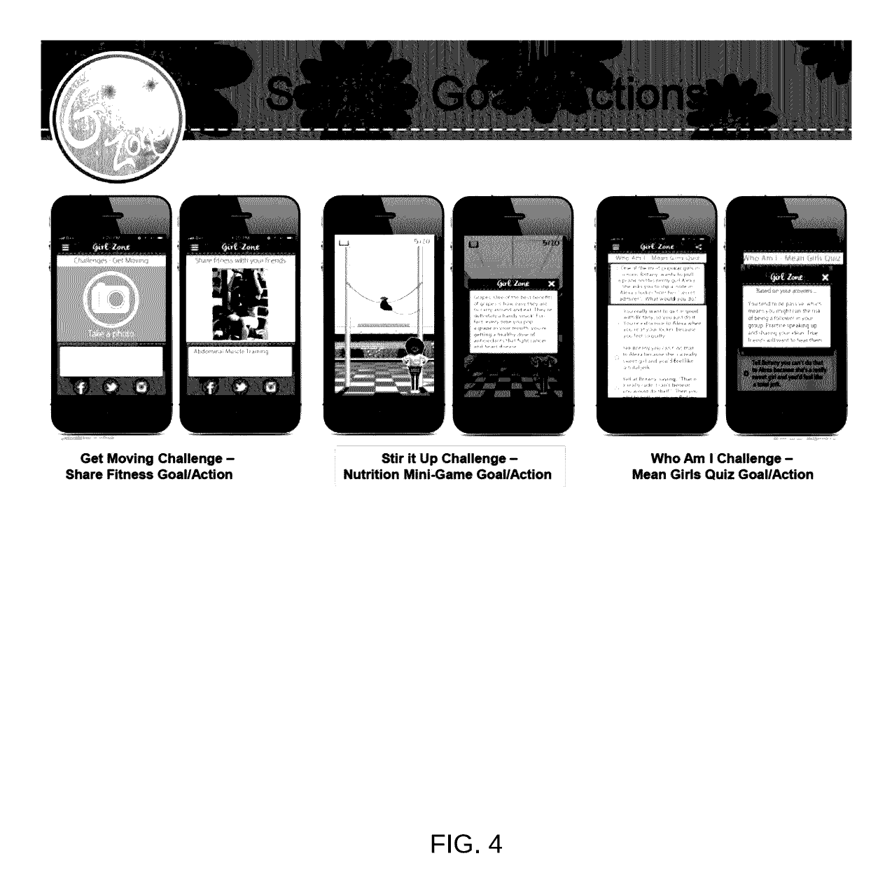

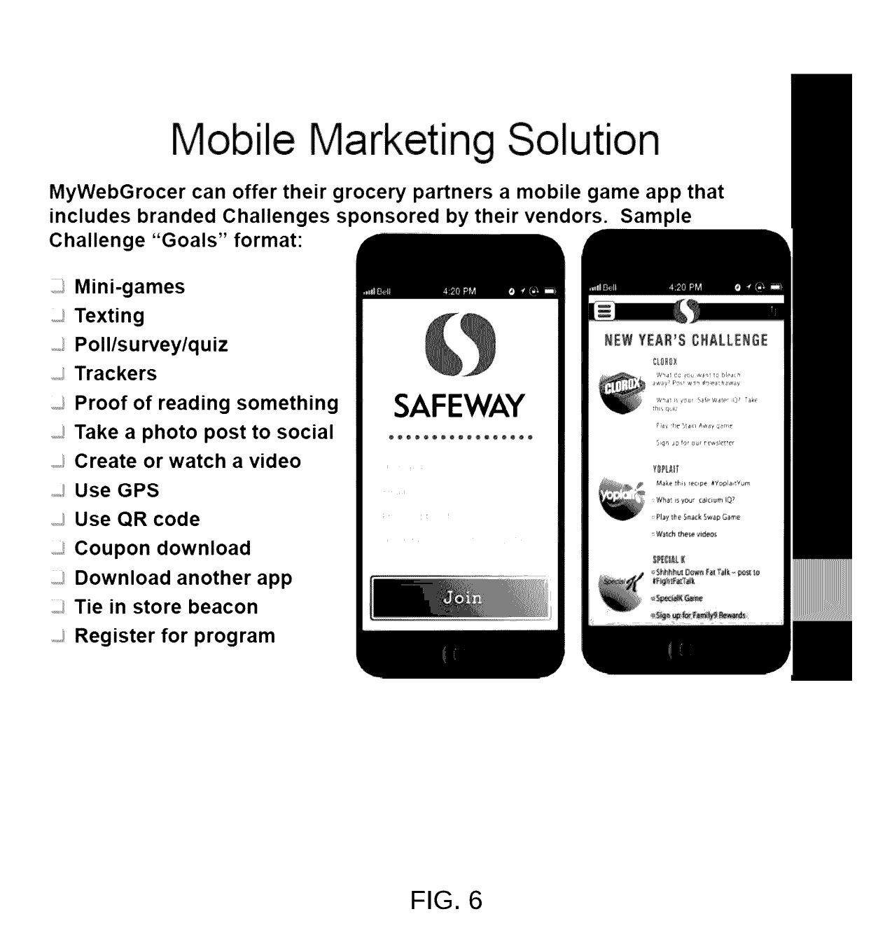

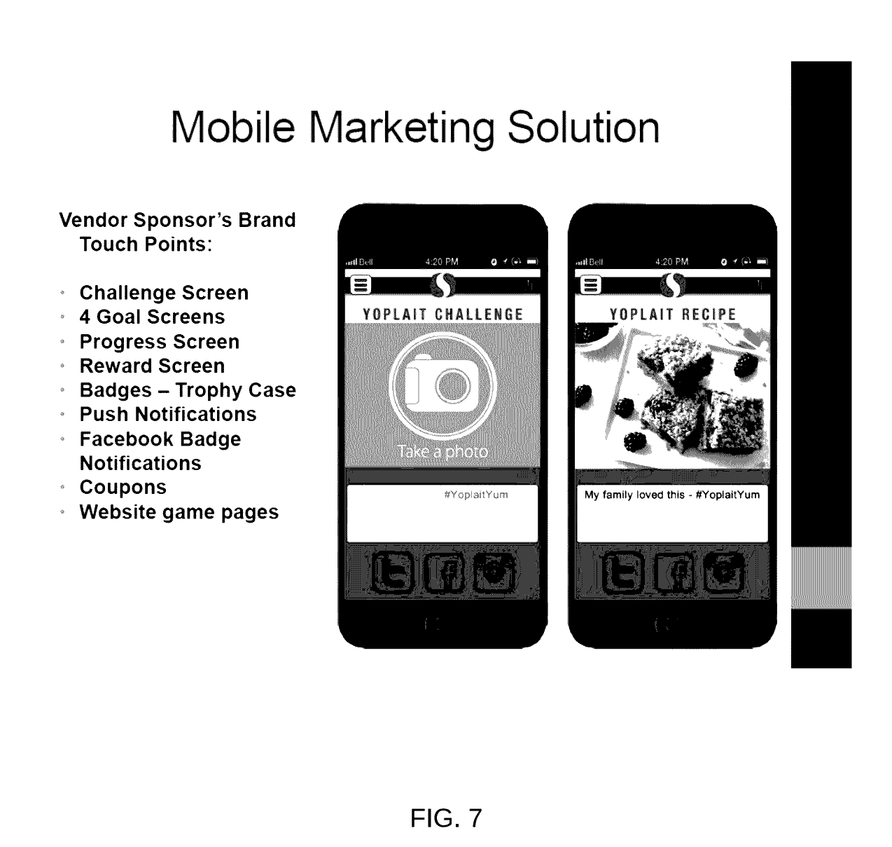

In an example embodiment, a method motivates a user to achieve a goal through an interactive electronic interface. The interactive electronic interface may be web based, or may a standalone application that is installed on an electronic device. The method selects electronic content relevant to the goal. For example, as illustrated in FIG. 3 and FIG. 4, the electronic content is represented as several challenges related to health and wellbeing. The challenges are geared toward young girls and young ladies. FIG. 6 and FIG. 7 illustrate example electronic content represented as challenges related toward grocery store products. In this example scenario, the challenges are geared toward consumers of grocery stores, and particular products sold in grocery stores.

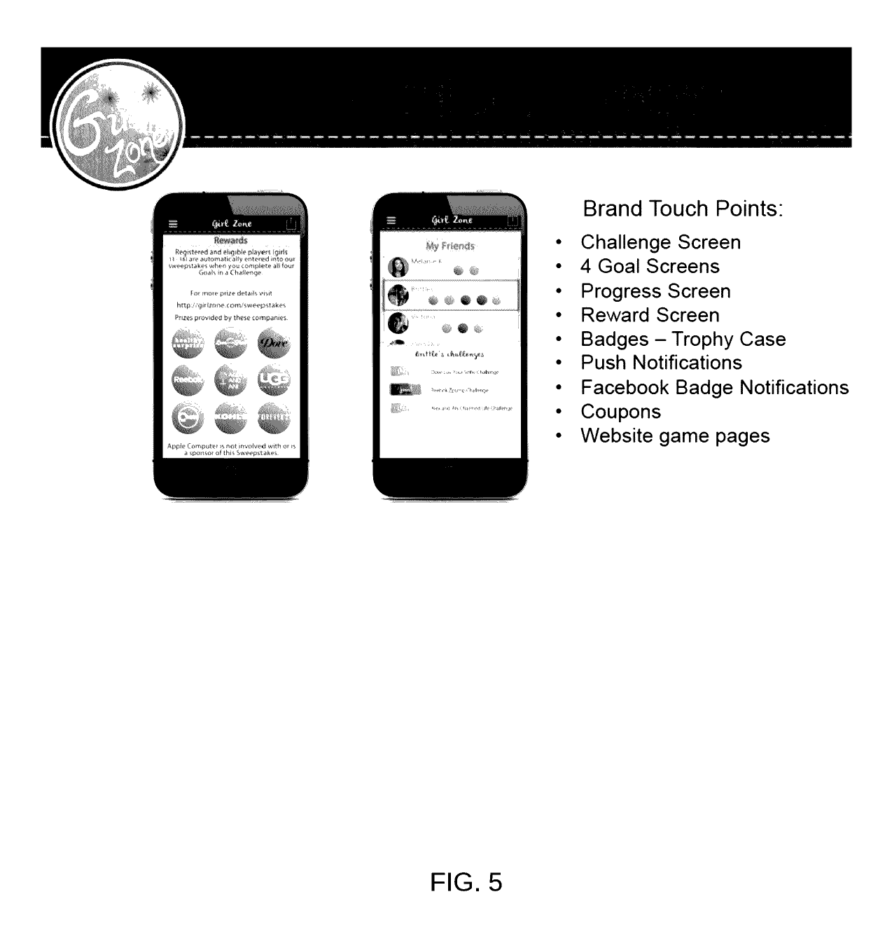

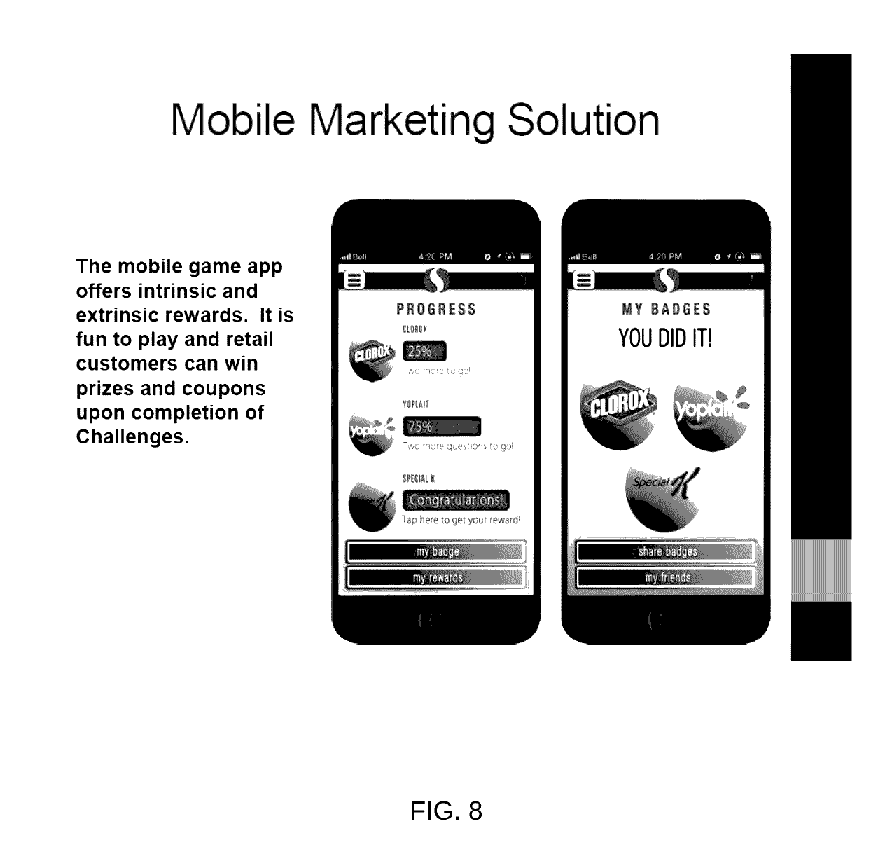

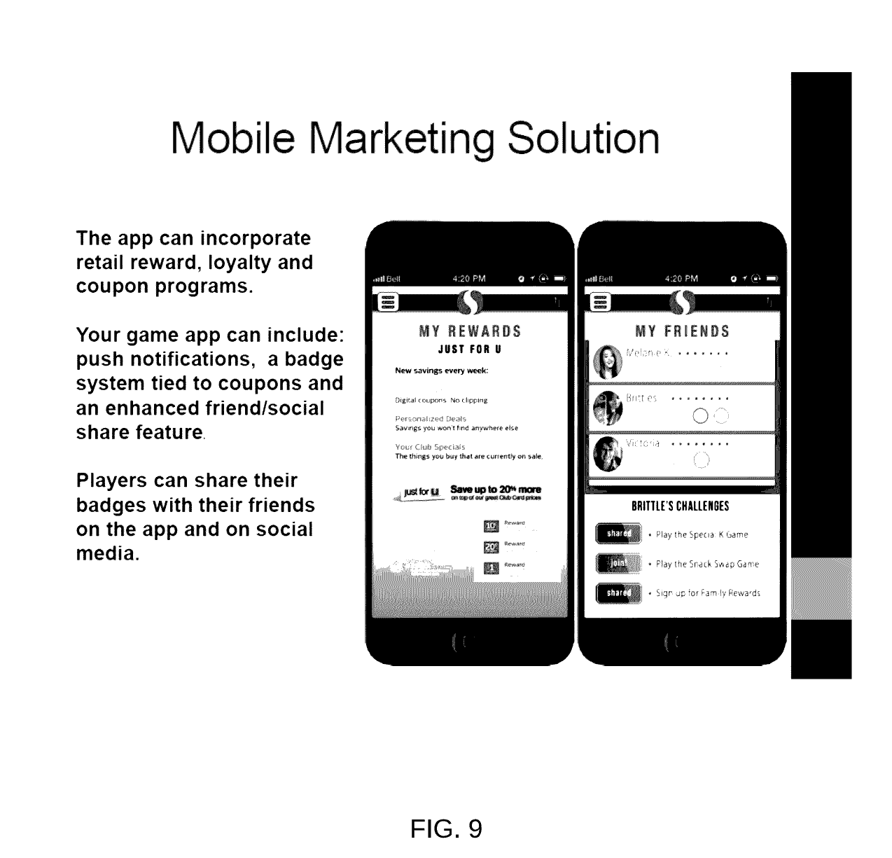

In an example embodiment, the method correlates the electronic content with at least one electronically interactive incentive geared toward achieving the goal. As illustrated in FIG. 5, the method correlates the electronic content with an electronically interactive incentive. Here, the electronic content is a series of challenges geared toward health and wellbeing for young girls and young ladies, and the electronically interactive incentive is a series of rewards that the users can earn. For example, users who complete the series of challenges may be entered into a sweepstakes, or may win a reward. FIG. 8 and FIG. 9 illustrate another example embodiment of the method correlating the electronic content with an electronically interactive incentive. Here, there are a series of challenges related to grocery store products. The electronically interactive incentives are rewards geared toward consumers.

In an example embodiment, the method presents a challenge to the user via an electronic interface, where the challenge comprises at least one of the electronic content and at least one individualized electronically interactive incentive. FIG. 3 illustrates an example challenge delivered on a user's smartphone. Here, the challenge comprises quizzes, social shares, and/or mini-games. The challenge may also comprise an electronically interactive incentive, for example, offering the user an electronic or physical reward if the user completes certain tasks (such as taking a quiz, playing a game, etc.) via the electronic interactive interface.

In an example embodiment, the method receives, via the electronic interface, a response to the challenge from the user. For example, the user interacts with the electronic content (such as taking a quiz, sharing content on social media, playing a game, etc.), via the electronic interface (such as a smartphone).

In an example embodiment, the method tracks the user's progress toward attaining at least one electronically interactive incentive by electronically monitoring the account associated with the user. The method renders a representation of the user's progress for the user via the electronic interface. As illustrated in FIGS. 3, 5, 8, and 9, the method tracks the user's progress as the user interacts with the electronic content and the electronically interactive incentives. In one example embodiment, the electronically interactive incentive may be individualized for the user. The method also renders a representation of the user's progress through the electronic interface. In another example embodiment, the user may compare their own progress with the progress of other users. In this example scenario, the method renders a representation of progress for each of the other users' progress on the electronic interface associated with the user.

In an example embodiment, the method provides the user with an option to receive at least one electronically interactive incentive as a physical item when the user has attained at least one electronically interactive incentive. For example, the user may trade the electronically interactive incentive for a physical item, such as a coupon, prize, or other physical reward.

In an example embodiment, when the method correlates the electronic content with at least one electronically interactive incentive geared toward achieving the goal, the method solicits at least one of the electronic content and the electronically interactive incentive from a provider as a means of advertisement for the provider. For example, a provider such as a manufacturer or merchant of a product may sponsor the challenge and/or the electronically interactive incentive as a way to provide advertisement for the manufacturer or merchant. The manufacturer or merchant may pay a fee to have a challenge and/or the electronically interactive incentive presented to the user.

As will be appreciated, the invention described herein provides a system and method for increasing health, lifestyle and fitness awareness by providing electronic teaching modules, social networking modules, gaming modules, incentive modules, and a structured reward system to participants.

Having thus described several illustrative embodiments, it is to be appreciated that various alteration, modifications, and improvements will readily occur to those skilled in the art. Such alterations, modifications, and improvements are intended to form a part of this invention, and are intended to be within the spirit and scope of this invention. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments. Additionally, elements and components described herein may be further divided into additional components or joined together to form fewer components for performing the same functions. Accordingly, the foregoing description and attached drawings are by way of example only, and are not intended to be limiting. While various embodiments of the invention have been particularly shown and described, it will be understood by those skilled in the art that various changes in form and details may be made therein without departing from the spirit and scope of the invention as defined by the appended claims.

What is claimed is:

1. A method for motivating a user to achieve a goal, the method comprising:
selecting electronic content relevant to the goal;
correlating the electronic content with at least one electronically interactive incentive geared toward achieving the goal;
presenting a challenge to the user via an electronic interface, wherein the challenge comprises at least one of the electronic content and the at least one individualized electronically interactive incentive;
receiving, via the electronic interface, a response to the challenge from the user; and
tracking the user's progress toward attaining the at least one electronically interactive incentive by electronically monitoring the account associated with the user.

2. The method of claim 1 further comprising:
rendering a representation of the user's progress for the user via the electronic interface.

3. The method of claim 1 further comprising:
providing the user with an option to receive the at least one electronically interactive incentive as a physical item when the user has attained the at least one electronically interactive incentive.

4. The method of claim 1 wherein correlating the electronic content with the at least one electronically interactive incentive geared toward achieving the goal comprises:
soliciting at least one of the electronic content and the at least one electronically interactive incentive from a provider as a means of advertisement for the provider.

5. A computer program product for motivating a user to achieve a goal, the computer program product comprising: a non-transitory computer readable memory device having computer readable program code embodied therewith, the computer readable program code configured to:
select electronic content relevant to the goal;
correlate the electronic content with at least one electronically interactive incentive geared toward achieving the goal;
present a challenge to the user via an electronic interface, wherein the challenge comprises at least one of the electronic content and the at least one individualized electronically interactive incentive;
receive, via the electronic interface, a response to the challenge from the user; and
track the user's progress toward attaining the at least one electronically interactive incentive by electronically monitoring the account associated with the user.

6. A system comprising: a processor; and a non-transitory computer readable memory device, having computer readable program code embodied therewith, the computer readable program code configured to:
select electronic content relevant to the goal;
correlate the electronic content with at least one electronically interactive incentive geared toward achieving the goal;
present a challenge to the user via an electronic interface, wherein the challenge comprises at least one of the electronic content and the at least one individualized electronically interactive incentive;
receive, via the electronic interface, a response to the challenge from the user; and
track the user's progress toward attaining the at least one electronically interactive incentive by electronically monitoring the account associated with the user.
